(19) United States
(12) Patent Application Publication
(10) Pub. No.: US 2010/0083525 A1
(43) Pub. Date: Apr. 8, 2010

(54) DEVICE AND METHOD FOR HEAT-TREATING A POURABLE PLANT PRODUCT

(75) Inventors: Stephan Lange, Emmerich Amrhein (DE); Gerhard A. Jansen, JH's Heerenberg (NL)

Correspondence Address: MAIER & MAIER, PLLC, 1000 DUKE STREET, ALEXANDRIA, VA, 22314, US

(73) Assignee: PROBAT-WERKE VON GIMBORN MASCHINENFABRIK GMBH, EMMERICH AM RHEIN (DE)

(21) Appl. No.: 12/524,590

(22) PCT Filed: Jan. 8, 2008
(86) PCT No.: PCT/EP08/50135

§ 371 Date: Jul. 27, 2009

(30) Foreign Application Priority Data
Feb. 8, 2007 (DE) 10-2007-006-268.2

(51) Int. Cl. A23N 12/10; F26B 11/02

(52) U.S. Cl. 34/443; 34/132

(57) ABSTRACT

A device for heat-treating a pourable plant product, in particular for roasting coffee beans, comprises a roasting vessel. The roasting vessel is formed by a rotor bowl and a lid device. The rotor bowl is rotated relative to the lid device about a vertical axis by means of a drive means. A hot air generator is connected to the roasting vessel via a feed channel. According to the invention, the hot air generator and the feed channel are components of the, in particular fixed, lid device.

### RELATED APPLICATIONS

The present invention claims priority under 35 U.S.C. §119 to German Patent Application No. 10 2007 006 268.2, filed on Feb. 8, 2007, the disclosure of which is incorporated by reference herein in its entirety.

### BACKGROUND

The invention relates to a device and a method for heat-treating a pourable product, in particular for roasting and cooling a pourable plant product.

Pourable plant products are understood herein as beans, cores and seeds which under the influence of centrifugal force can be subjected to a radial-peripheral agitation. The heat treatment of the product is a heat treatment effected largely by convection of streaming hot air. Preferably, the heat treatment is performed with automatically controlled temperature and automatically controlled volume flow. The relative speed required for convection is generated preferably by the fast movement of the product particles due to the centrifugal force, in relation to the slower flow of the hot air.

In the state of the art, various devices for heat treatment, cold treatment and/or treatment by means of substances are known.

DE 21 03 281 C3 describes a device for heat treatment, cold treatment and/or treatment by substances of a granular pourable product, particularly for roasting coffee beans or cocoa beans, wherein, under the influence of the centrifugal force, the product is conveyed beyond the edge of a vessel. The vessel has at least approximately the shape of a rotation paraboloid. Above the vessel, at a small distance from the edge of the vessel in relation to the dimensions of the product, a lid arranged is provided, arranged for rotation in the opposite sense relative to the vessel and equipped with curved guide blades or ribs which extend to positions near the center of the lid. The vessel and the rotating lid are surrounded by a housing for accommodating the coffee beans which, when the vessel is being emptied, will emerge from the gap between the vessel edge and the lid.

DE 23 41 099 C2 describes a device for subjecting a granular, pourable product to a heat treatment, cold treatment and/or treatment with the aid of substances, particularly for roasting coffee beans, comprising a downwardly tapering vessel, with its axis arranged in vertical orientation, in which the product is subjected to a treatment flow substantially in upward direction. In this process, under the influence of centrifugal forces, the product is conveyed beyond the edge of the vessel and, above the vessel, is deflected by curved, slightly twisted guide blades or ribs of a lid rotating in the opposite sense relative to the vessel. The treatment flow is supplied via a tube extending through the lid into the vessel and arranged coaxially to the vessel. The tube with its deflection edge is adjustable relative to the bottom of the vessel and thus allows for control of the treatment flow. Further, said tube also serves for supply of the coffee beans which are to be roasted.

The treatment flow is a mixture of hot exhaust air and fresh air generated in a hot-air generator, said mixture being supplied to the above mentioned tube from a mixing station. Arranged upstream before the mixing station are a conduit and a reheater consisting of a burner and a combustion chamber.

The solutions according to the state of the art often have a large space requirement for the accessories of the system such as, e.g., the hot-air generator. This entails the need for long tube conduits with elaborate insulation. The recovery of heat on the one hand and the development of the process on the other hand are difficult to control and often cannot be carried out in a reproducible manner. In case of changes of the pourable product, said agitation movement can be optimized only to a limited extent.

### SUMMARY

It is an object of the invention to provide a device for heat-treating a pourable plant product, which can be given a very compact design. Further, it is an object of the invention to lend increased effectiveness to a method for operating a device for heat-treating a pourable plant product.

According to the invention, the object is achieved by a device according to claim 1 and respectively a method according to claim 22.

Products for treatment in the sense of the invention are to be defined as comprising generally all pourable and free-flowing plant products. For simplification of the further explanation of the invention, the heat treatment of a product is to be understood herein as the roasting and cooling of coffee beans which are fed into the device.

The inventive device for heat-treating a pourable plant product, which device is suited in particular for roasting coffee beans, comprises a roasting vessel into which the coffee beans will be fed. The roasting vessel comprises a rotor bowl and a lid device. The rotor bowl and/or the lid device are connected to a drive means for rotating the rotor bowl relative to the lid device. With preference, it is the rotor bowl which will be rotated, while the lid device is preferably stationary. The rotation herein is performed about a vertical axis. By rotation of the rotor bowl, centrifugal forces will be acting on the coffee beans so that, in the bowl, the beans will be conveyed along the inner wall of the bowl upwards in the direction of a lid inner side of a lid of the lid device. From the lid, which preferably is provided with guide sheets which are substantially radial and—if required—curved, the beans will be conveyed, in the direction of the rotational axis, back toward the interior and thus will again reach a lower region or bottom region of the rotor bowl. Further, the inventive device comprises a hot-air generator for heating supplied air. The hot-air generator is connected to the roasting vessel via a feed tube. According to the invention, the hot-air generator as well as the feed channel are components of the preferably stationary lid device. This allows for an extremely compact design. Thus, it is not required to provide long tube conduits, particularly of the type requiring insulation, in order to connect the hot-air generator to the roasting vessel. Thereby, one can achieve not only a compact design but also an inexpensive configuration of the inventive roasting device.

By the novel arrangement and configuration of the hot-air generator, there is realized, on the one hand, an especially compact design of the device and, on the other hand, the heat loss is minimized and the heat recovery is improved. It is found to be of particular advantage that the inventive device, when started, can be put into operation after a particularly short warm-up period. The temperature and volume control of the hot air is not impaired by feed lines of different lengths, as have been used in the state of the art.

Preferably, the hot-air generator is arranged above the rotor bowl. Preferably, herein, the weight of the hot-air generator is supported by the lid device. In this arrangement, it is particularly preferred to provide the hot-air generator symmetrically to the rotational axis of the rotor bowl. Herein, it is preferred that, at least in the region of a lid opening for passage of the hot air into the roasting vessel, the feed channel is arranged vertically. It is particularly preferred that, between the hot-air generator and the roasting vessel, the feed channel is arranged vertically throughout. In this case, the supply of hot air is performed via a feed channel arranged preferably centrally with regard to the roasting vessel. The rotor axis, i.e. the rotational axis of the rotor bowl, is thus arranged with rotational symmetry relative to the center axis of the feed channel—which is preferably shaped as a circular cylinder—so that the two axes are identical.

Preferably, the inventive roasting device further comprises at least one additional channel. Said at least one additional channel preferably surrounds the feed channel, while the at least one additional channel can have the shape of a circular ring. Preferably, the at least one additional channel is operative to conduct exhaust air flows, i.e. air to be discharged from the roasting vessel.

According to a particularly preferred embodiment of the inventive roasting device, there is further provided a recirculation means. With the aid of the recirculation means, partial flows of the exhaust air will be again supplied to the roasting vessel. For this purpose, the recirculation means is connected to said at least one additional channel and respectively said additional channels. For control of the volume of a process exhaust air flow which is again supplied to the roasting process, the recirculation means preferably comprises a plurality of control means, preferably in the form of controllable flaps. Thereby, it is rendered possible to subdivide the process exhaust air flow into two or more partial flows. Herein, it is of advantage that, for insulation and for heat exchange, the exhaust air flows of the process are conducted through additional channels which at least partially surround the feed channel. Preferably, the control means of the recirculation means is arranged in the inlet connector of the hot-air generator.

Preferably, the lid of the lid device has its inner side provided with a plurality of preferably radial guide blades which preferably have a curved shape. With the aid of these guide blades, the coffee beans which under the influence of the centrifugal force are conveyed upwards on the inner side of the rotor bowl, will again be guided inwards in the direction of the rotational axis and will fall back into the rotor bowl. To allow for a particularly gentle roasting of the coffee beans, the guide blades are preferably curved.

In the roasting vessel, there is preferably provided a shaped body which is connected e.g. to the lid. Preferably, said shaped body is arranged in the top space, i.e. in the upper region of the roasting vessel. The shaped body is preferably made of sheet metal. Preferably, the shaped body is configured in such a manner that an underside of the shaped body is inclined towards the interior in the direction of the rotational axis so that, by means of the shaped body, coffee beans conveyed towards the interior with the aid of the guide blades will be deflected downwards into the rotor bowl. Further, the shaped body is preferably configured to the effect that a distance exists between the shaped body and an inner side of the lid. In this manner, an exhaust air channel is formed for conducting exhaust air from the roasting vessel into one of said additional channels. Preferably, herein, the exhaust air channel and respectively the gap formed between the inner side of the lid and the shaped body, has an annular cross section preferably extending with a frustoconical shape in the direction of the additional channel.

A fill-in tube preferably arranged above the lid and, if desired, to the side of the feed channel, is connected to the roasting vessel. Preferably, said fill-in tube is arranged to pass through the shaped body. The fill-in tube is preferably provided with a slider, with a feed container arranged before said slider when viewed in the direction of introduction. Via said feed container, by actuating the slider, coffee beans can be supplied in batches to the roasting vessel. The feeding is preferably effected by gravity.

Further, the roasting vessel comprises a discharge opening which preferably is arranged in the lid device. With preference, the discharge opening is arranged in the region of the guide blades, i.e. in an outer region of the lid. The discharge opening preferably comprises a closure element which is preferably removable in an upward direction and is preferably shaped as a sector of an arc. Said closure element can have one or a plurality of guide blades fastened thereto. This arrangement makes it possible, by simply opening the discharge opening with resultant removal of one or a plurality of guide blades, to remove roasted beans from the roasting vessel. The coffee beans are conveyed out of the roasting vessel by the centrifugal forces acting on the coffee beans. The coffee beans conveyed out of the roasting vessel are supplied to a cooling unit such as e.g. a cooler of the type with turbulent fluidized bed.

The inventive device for heat-treating a pourable plant product, which is an invention in its own right, comprises a multi-part rotor bowl. In particular, said rotor bowl comprises a double-walled outer bowl which between two preferably frustoconical walls of sheet metal is filled with an insulating substance which preferably comprises a mineral material. This has the advantage that an annular gap existing between the rotor bowl and the stationary lid device can be given a relatively small size. Thereby, it is prevented that coffee beans will be flung through the annular gap.

Preferably, a single-walled inner bowl, preferably made of sheet metal, is inserted from above into the outer bowl and attached thereto by a screw connection. Thus, the inner bowl can be exchanged in an easy manner and be replaced, e.g., by a bowl having a different inner contour. This makes it possible, for instance, to adapt the inclinations of the inner bowl to the diameter.

Further, the nature of the surface of the inner bowl can be selected to the effect that the surface is adapted to the specific mass of the individual particles of the pourable product. Further, by suitable selection of the shape of the inner bowl, one can obtain a good adaptation to the rotational speed of the rotor bowl.

The inventive device is preferably designed as a batch-type system and substantially comprises, apart from the roasting vessel wherein the heat treatment takes place, a cooler of the type with turbulent fluidized bed for abrupt cooling of the product by means of cold air immediately after heat treatment.

In this embodiment of the invention, said multi-walled bowl of the rotor can be equipped with inner bowls of different shapes for different types of coffee beans. The raw coffee beans as well as, finally, the made-for-use coffee beans will be set into the best possible agitation movement in accordance with the specific nature of the coffee.

Those inclinations of the inner bowl at the respective inner diameter which are advantageous in practice will be determined respectively by the mass of the coffee beans or of the pourable products in combination with the rotational speed of the rotor. The device can thus be advantageously used for selective heat treatment under consideration of the mass of very different pourable products.

The invention further relates to a method for operating a device of the above described type for heat-treating a pourable plant product, said heat treatment being preferably the roasting of coffee beans. The inventive device preferably serves for operation of the above described inventive device. During operation, according to said method, the hot air flow is circulated through a roasting vessel, particularly with interposition of a particle separator. In the process, a supply air flow generated by a hot-air generator is supplied to the hot air flow. During operation, as provided by the invention, a mass flow of hot air of substantially constant quantity is conveyed along a circulating path. Conveyance herein is performed preferably via a particle separator such as, e.g., a cyclone. For conveying the hot air flow, there is preferably provided a ventilator. At the same time, the roasting air is preferably controlled in its quantity in such a manner that the air is supplied from the hot-air generator into the roasting vessel according to the technological requirements.

It is particularly preferred that, in the first process phase wherein the coffee beans are dried in the roasting vessel, the volumes of the partial flows are controlled—preferably automatically—in dependence on a pressure within the roasting vessel. During the subsequent roasting of the coffee beans by hot air, the chemical transformations in the coffee beans and thus the generation of the aroma and the flavor additives can be controlled in a well-aimed manner. For this purpose, it is required that, in a predetermined roasting period, both the temporal development of the heat flow into the interior of the coffee beans and the temporal development of the temperature of the coffee beans on the surface will be exactly controlled according to predetermined curve profiles.

During the roasting phase, the heat flow into the interior of the coffee beans will for the most part change, on the one hand, in dependence on the temperature difference between the hot air and the coffee beans and, on the other hand, in dependence on the heat transition coefficient on the surface of the coffee beans. Said heat transition coefficient will change along with different flow speeds of the hot air along the surfaces of the coffee beans. Therefore, a particularly preferred variant of the method provides that, in the roasting phase, with the aid of programmed control, both the temporal development of the temperature of the hot air streaming into the roasting vessel and the mass flow of this hot air will be controlled according to desired development curves.

According to the invention, the relatively constant hot air flow conveyed by the ventilator will be subdivided into at least three partial flows. A first partial flow will fully circulate, i.e. into the hot-air generator where the flow, by mixing with the burner exhaust gases, will be heated by direct heat exchange and then enter the roasting vessel. A second partial flow will be conducted through an additional channel where it will be indirectly heated on the wall of the additional channel and then, via an exhaust cleaner, will be discharged to the outside. The third partial flow will not be supplied into the hot-air generator and not into the roasting vessel but will be conveyed as a bypass flow past the generator and the vessel and be supplied directly to the particle separator, such as e.g. the cyclone.

With the aid of the inventive device as well as the inventive method which is used particularly for operating the device, it is thus possible to achieve a high productivity, while requiring reduced technical expenditure. A further advantage of the invention resides in the possibility of an improved, fully automated process control with high heat recovery and high availability.

The invention will be explained in greater detail hereunder with reference to a drawing. The illustrated embodiment is a coffee roasting machine with an attached cooler of the type with turbulent fluidized bed.

### BRIEF DESCRIPTION OF THE FIGURES

FIG. 1 is a schematic sectional view.

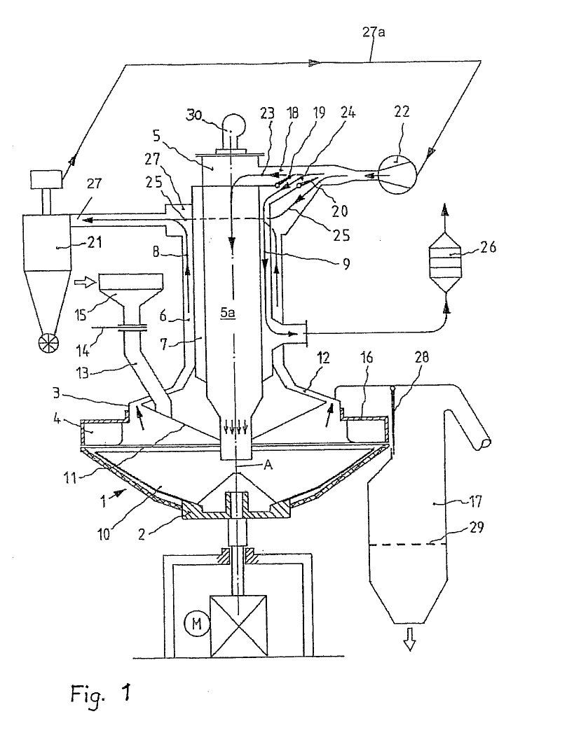

### DETAILED DESCRIPTION

The inventive device comprises a roasting vessel 1 provided with a lower rotor 2 arranged to be motorically driven by a motor M and to rotate about its vertical axis A. Rotor 2 is formed as a rotor bowl and comprises an easily exchangeable inner bowl 10. Rotor 2 is driven at such a high speed that, under the influence of the centrifugal force, the coffee beans contained in said inner bowl 10 will be conveyed beyond the edge of rotor bowl 2. Located above rotor 2 is a stationary lid device 3 whose lower edge during operation is arranged only at a small distance from the upper edge of rotor bowl 2. In a peripheral annular region, lid device 3 carries on its underside guide blades 4 which are shaped to the effect that the coffee beans will slide in an impact and thrust-free manner along the inner surfaces and in the process will be deflected in centric direction, i.e. towards the interior.

According to the invention, preferably, the lid device 3 together with the hot-air generator 5 forms one unit as an upper closure of roasting vessel 1. From hot-air generator 5, the hot air is blown vertically downward as well as symmetrically into roasting vessel 1. After heat transmission from the hot air to the coffee beans, the process exhaust air will be discharged via the additional channel 12. Additional channel 12 is delimited on one end by shaped body 11 made of sheet metal and on the other end by the outer shell of lid device 3.

The flow of process exhaust air 8 will then, via channel 6, reach the bypass channel 27. Therein, the flow of process exhaust air 8 will be mixed with the partial flow 25. These two united exhaust air flows will enter a particle separator such as e.g. a cyclone 21. In the cyclone 21, the solid portions will be separated from the exhaust air. The ventilator 22 will suck the thus cleaned air and convey it to the inlet connector 18. Internally of inlet connector 18, guide sheets and control flaps 19,20 are arranged in such a manner that the entering air flow will be branched into three partial flows. The first partial flow 23 will enter the interior of hot-air generator 5 and there, in direct heat exchange, will be brought onto the temperature level of the roasting air by the gas flame of the forced-air burner 30 through automatic control by a per se known temperature control device. The control flap 19 will automatically control the free cross section for the excess volume flow 9 in dependence on the absolute pressure in roasting vessel 1. The excess volume flow will stream into the channel 7 arranged concentrically around hot-air generator 5 and will be heated up on the wall of hot-air generator 5 by indirect heat absorption.

Then, the excess volume flow 9 will be guided into the exhaust gas cleaning system 26 where the gaseous organic substances existent in the exhaust air will be burned. The combustion can generally be of the catalytic, thermal or flameless regenerative type. In any case, it turns out to be very advantageous that, prior to being burned, the excess volume flow 9 will be heated to a higher temperature level within channel 7. After the gaseous organic substances have been burned, the exhaust air from the exhaust gas cleaning system 26 is in compliance with the emission requirements and will be discharged into the environment.

The control flap 20 automatically controls the volume of the partial flow 25 in dependence on a variable command value for the volume flow of the process air. The partial flow 25 is guided to bypass channel 27 and thus remains in the hot-air circuit without, however, passing the hot-air generator 5 and the roasting vessel 1.

For the separation of solids in the cyclone 21 and for the conveyance of hot air performed by ventilator 22, it is of advantage that the volume flow of these devices as the sum of the partial flows 8 and 25 will always remain relatively constant while, at the same time, the individual partial flows 23, 24 and 25 which in their totality constitute 100% of the circulating volume flow, can be controlled within wide ranges.

The feeding of the to-be-roasted coffee beans into the roasting vessel 1 takes place, under the influence of gravity, from the feed container 15 via a closeable slider 14 and via a feed-in tube 13 passing through the shaped body 11 made of sheet metal. It has proven to be advantageous if the coffee beans are caused to impinge outside the center, within the inner third of the rotating inner bowl 10. Immediately after impinging onto inner bowl 10, the coffee beans will be guided into a radial-tangential moving direction and thereafter, in the outer portion of the inner bowl, increasingly into a vertical-tangential moving direction. The rotational speed of rotor 2 is selected in such a manner that, by the kinetic energy, the coffee beans will be moved beyond the outer edge of rotor 2 up into the guide blades 4 of lid device 3. In the effective range of the guide blades 4, the coffee beans will slide in an impact-free manner along the inner surface of the guide blades 4 and, at the same time, will be substantially deflected from the vertical-tangential moving direction into a centric direction. After leaving the guide blades 4, the coffee beans will fly again into the inner bowl 10, and the cycle of a uniform, intensive agitation of the coffee beans will be started again, with the hot air flowing around the coffee beans simultaneously and on all sides.

The lid device 3 is formed with an exit-sluice opening which in the process phase “roasting” is closed in an edge- and gap-free manner by the liftable circular portion 16. For discharge of the completely roasted batch of coffee beans, the liftable circular portion 16 will be moved vertically upwards by means of pneumatic or hydraulic cylinders, not shown. Like the rest of the circumferential region of the lid device 3, also the circular portion 16 has guide blades 4 fastened thereto. In the lifted condition of the circular portion 16, the coffee beans, which within rotor 2 have been moved upwards by the centrifugal force, will exit from the roasting vessel 1 as guided by the guide blades 4 of the circular portion. The flap 28 will open and allow the coffee beans to slide onto the screen-like bottom 29 of the cooler 17 with turbulent fluidized bed. Then, the coffee beans will be cooled in a manner known per se by throughflow of cold air.

As can be gathered particularly from the drawing, the hot-air generator 5 as well as the feed channel 5a formed by a cylindrical tube and arranged between hot-air generator 5 and roasting vessel 1, are components of the lid device 3.

What is claimed is:

1. A device for heat-treating a pourable plant product, in particular for roasting coffee beans, said device comprising:
a roasting vessel formed by a rotor bowl and a lid device,
a drive mechanism to rotate the rotor bowl relative to the lid device about an axis, and
a hot air generator connected to the roasting vessel via a feed channel,
wherein the hot air generator and the feed channel are components of the lid device.

2. The device according to claim 1, wherein the lid device is stationary and said axis is vertical.

3. The device according to claim 1, wherein the hot-air generator is arranged above the rotor bowl.

4. The device according to claim 1, wherein the feed channel is arranged vertically at least in the region of a lid opening provided for passage of hot air into the roasting vessel.

5. The device according to claim 1, wherein the feed channel is arranged centrally, with axial symmetry, relative to the axis of the rotor bowl.

6. The device according to claim 1, wherein at least one additional channel is provided, surrounding the feed channel and provided to conduct exhaust air flows.

7. The device according to claim 6, wherein said at least one additional channel surrounds the feed channel in a circular configuration.

8. The device according to claim 1, wherein a recirculation mechanism is engagedly coupled to at least one additional channel and the feed channel.

9. The device according to claim 8, wherein said recirculation mechanism further comprises control flaps, to supply an exhaust air flow of the process to different channels.

10. The device according to claim 8, wherein said control devices control are arranged in the inlet connector of the hot-air generator.

11. The device according to claim 1, wherein guide blades are coupled to a lid inner side of the lid device.

12. The device according to claim 1, wherein the rotor bowl is of a multi-wall type which comprises an internally arranged inner bowl.

13. The device according to claim 12, wherein said inner bowl is exchangeable.

14. The device according to claim 2, wherein a gap is formed between the rotor bowl and the stationary lid device.

15. The device according to claim 1, wherein, within the roasting vessel, in the top region thereof, a shaped body is connected to the lid device.

16. The device according to claim 15, wherein said shaped body is arranged at a distance from an inner side of the lid, for providing at least one exhaust-air channel for processing exhaust air flows.

17. The device according to claim 16, wherein said exhaust-air channel has an annular cross section, and has a substantially frustoconical shape.

18. The device according to claim 1, wherein an exhaust-air channel is connected to at least one additional channel.

19. The device according to claim 1, wherein a feed-in tube passes through a shaped body.

20. The device according to claim 1, wherein the lid device is provided with an exit opening.

21. The device according to claim 20, wherein said exit opening is connected via an outlet channel to a cooling device.

22. A method for operating a device for heat-treating a pourable plant product comprising:
conducting a hot air flow to circulate through a roasting vessel with interposition of a particle separator;
subdividing the hot air flow into partial flows; and
circulating or returning a first partial flow to the roasting vessel.

23. The method according to claim 22, further comprising controlling volumes of the partial flows in dependence on a pressure in the roasting vessel.

24. The device according to claim 1, wherein the lid device is stationary or said axis is vertical.

25. The device according to claim 1, wherein a recirculation mechanism is engagedly coupled to at least one additional channel or the feed channel.

26. The method according to claim 22, wherein said first partial flow is supplied to the hot-air generator.

27. The method according to claim 22, wherein a second partial flow is discharged via an exhaust gas cleaning system.

28. The method according to claim 22, wherein, with respect to the hot-air generator and the roasting vessel, a third partial flow is supplied as a bypass flow directly to the particle separator.
